(19) United States
(12) Patent Application Publication
(10) Pub. No.: US 2003/0166396 A1
(43) Pub. Date: Sep. 4, 2003

(54) Method for crediting a prepaid account

(76) Inventors: Brigitte Vermelle, Lancon De Provence (FR); Philippe Dumay, Marseille (FR)

Correspondence Address: BURNS DOANE SWECKER & MATHIS L L P, POST OFFICE BOX 1404, ALEXANDRIA, VA, 22313-1404, US

(21) Appl. No.: 10/275,103

(22) PCT Filed: May 7, 2001
(86) PCT No.: PCT/FR01/01386

(30) Foreign Application Priority Data
May 16, 2000 (FR) 00/06340

(51) Int. Cl. H04M 11/00; H04Q 7/20

(52) U.S. Cl. 455/406; 455/466; 455/558

(57) ABSTRACT

The invention concerns a method for crediting a prepaid account through a telecommunication network which consists in: recording in a terminal SIM card storage data identifying at least a banking card. When executing a programme stored in the card, transmitting to the prepaid account management service the data identifying the banking card or one of the banking cards and the desired amount to be credited. The prepaid account management service verifies the validity of the banking card, requests authorisation for the desired amount to be credited, and sends to the terminal SIM card report of the transaction (confirmation/failure).

The present invention concerns electronic commerce using prepaid accounts, in particular by means of a cellular radio telephony infrastructure.

Prepaid accounts are for example normally used for offering radio telephony services without subscription. The user can thus easily control the amount of his communications but must top up his account when his credit is exhausted. Various methods can be used for crediting the account, the most usual being the distribution of scratch cards on which codes are entered, covered with a removable opaque surface. The user purchases the card, and removes the removable surface so as to reveal the code, which he communicates to the operator. The operator checks the validity of the code, and credits the prepaid account with the amount associated with it.

This system is particularly adapted to cellular radio telephony of the GSM type, since the account is associated with the number of a SIM (standing for Subscriber Identity Module in English) smart card. On the other hand, it is not well adapted to mobile electronic commerce, since the user remains anonymous, and non-repudiation of the transactions is not ensured.

Likewise, the simple transmission of the data identifying a payment card does not provide sufficient security, since the data may correspond to a fictitious payment card or one used fraudulently.

In a cellular radio telephony network of the GSM type, provision is made for providing to the subscriber application services based on the execution of application programs within the SIM smart card. These services are implemented by a standard technology normally referred to as SIM Application Toolkit. One particularly functionality, known as proactivity, enables the SIM card, in running a program, to address requests to the outside word: the terminal, the subscriber and the network.

The objective of the invention is to propose a method of crediting a prepaid account, using the existing radio telephony infrastructures, which is particularly adapted to mobile electronic commerce.

To this end, a method of crediting a prepaid account by means of a telecommunication network is characterised in that it comprises the following steps:

recording, in the memory of the SIM card of a terminal, data identifying at least one payment card,

executing a program stored in the SIM card transmitting to the service managing the prepaid account data identifying the payment card or one of the payment cards and the amount credited,

checking the validity of the payment card and requesting authorisation for the amount credited,

sending a report on the transaction by the program managing the prepaid account to the SIM card.

In this way, the prepaid account can be credited without risk of repudiation and limiting the risks of fraud, whilst remaining simple to use for the user.

The step of executing the program of the method of the invention can be preceded by the sending, by the prepaid account management service to the SIM card, a request to credit the prepaid account.

The data can be recorded by a trustworthy person using a specially adapted terminal, in the presence of the owner of the payment card.

The method according to the invention can comprise a step during which a personal code, associated with the payment card or one of the payment cards, is recorded in the SIM card; the user having to supply the personal code associated with the payment card which he wishes to use, if the said code has been recorded in the SIM card, when the program recorded in the SIM card is executed.

In the method of crediting a prepaid account according to the invention, the transmissions between the SIM card and the service managing the prepaid account can take place by means of SMS messages; and the confidentiality and/or the integrity of the transmissions between the SIM card and the prepaid account management service can be ensured by virtue of the use of a private key recorded in the memory of the SIM card.

Other characteristics and advantages of the present invention will emerge more clearly from a reading of the following description of several preferred embodiments of the invention.

According to the invention, it is necessary to register the data of a payment card, typically its number, its expiry date and the name of its owner, in the memory of the SIM card of the portable telephone which is to be used. During this recording phase, the user physically goes to a trustworthy person in order to prove that he is indeed the legitimate owner of a payment card. This trustworthy person may for example be an employee of a radio telephony operator or the employee of a bank having an agreement with a radio telephony operator.

By means of a specially adapted terminal, the trustworthy person then records the data of the payment card in the memory of the SIM card of the portable telephone. The data may be entered manually or, in order to avoid any error in entry or reading, automatically by means of a payment card reader. The owner of the payment card can then define a personal code, which is recorded in the SIM card and which will be used to validate any operation of crediting his prepaid account associated with the SIM card. The terminal executes a particular computer program using cryptographic methods in order to generate an administrative code which is recorded in the SIM card. This administrative code will be necessary for any subsequent modification of the data contained in the file. For example in order to redefine a personal code if the latter has been forgotten by the holder of the payment card.

Optionally, several payment cards can be recorded in the SIM card, with an administrative code and, possibly, a personal code for each one.

Thus, for any addition or elimination of a payment card in the memory of the SIM card, the holder of the payment card must go to a trustworthy person equipped with the specially adapted terminal.

The user of the radio telephony terminal containing the SIM card is not necessarily the same person as the holder of the payment card. In this way parents can easily credit prepaid accounts for their children, which can then be used by the latter in order to telephone or make purchases.

During a crediting of his prepaid account according, to a first embodiment of the invention, the customer accesses a specific menu of the SIM card by means of his radio telephony terminal. By means of this menu, access to which may optionally be protected by a security code, the customer defines the amount which he wishes to transfer. Where applicable, he chooses a payment card whose data have been recorded in the SIM card, and enters the personal code associated with this card.

The application contained in the SIM card formats the transaction data in order to send them to the service managing the prepaid account, typically by means of SMS (standing for Short Message Service in English) messages.

The management service processes the transaction request using conventional means verifying the validity of the payment card and requesting authorisation for the amount credited, and returns to the SIM card the report on the transaction (confirmation or failure), also by means of SMS messages.

Optionally, the SMS messages can be made confidential using a private key which must in this case be recorded in the SIM card during its personalisation. Optionally, the integrity of the SMS messages may be guaranteed by calculating MAC (standing for Message Authentication Codes in English) certificates, also by means of a private key.

In a second embodiment of the invention, it is the account management service which sends a crediting request to the SIM card, typically by means of SMS messages.

Once the message has been received by the SIM card, the crediting takes place in the same way as in the first embodiment.

Optionally, the account management service is authenticated either by means of a signature using a private key, or by means of the original address contained in the SMSs.

Use of the prepaid account is not limited to mobile telephony. In the case of transactions whose amount exceeds the account credit, the retail service authenticates itself with the prepaid account management service, which will send a request according to the second embodiment.

Naturally, the use of SMS messages is not essential to the implementation of the invention: any other available channel making it possible to transmit the information may be used in its place.

1. A method of crediting a prepaid account by means of a telecommunication network, characterised in that it comprises the following steps:
recording, in the memory of the SIM card of a terminal, data identifying at least one payment card,
executing a program stored in the SIM card transmitting to the service managing the prepaid account data identifying the payment card or one of the payment cards and the amount credited,
checking the validity of the payment card and requesting authorisation for the amount credited,
sending a report on the transaction by the program managing the prepaid account to the SIM card.

2. A method of crediting a prepaid account according to claim 1, characterised in that the program execution step is preceded by the sending, by the prepaid account management service to the SIM card, of a request to credit the prepaid account.

3. A method of crediting a prepaid account according to claim 1 or 2, characterised in that the recording of the data is performed by a trustworthy person using a specially adapted terminal, in the presence of the owner of the payment card.

4. A method of crediting a prepaid account according to one of the preceding claims, characterised in that
a personal code, associated with the card or with one of the payment cards, is recorded in the memory of the SIM card
during the execution of the program, the user must provide the personal code associated with the payment card which he wishes to use, if the said code has been recorded in the SIM card.

5. A method of crediting a prepaid account according to one of the preceding claims, characterised in that the transmissions between the SIM card and the prepaid account management service take place by means of SMS messages.

6. A method of crediting a prepaid account according to one of the preceding claims, characterised in that the confidentiality and/or the integrity of the transmissions between the SIM card and the prepaid account management service is ensured by means of the use of a private key recorded in the SIM card.
